(19) United States
(12) Patent Application Publication
(10) Pub. No.: US 2006/0115554 A1
(43) Pub. Date: Jun. 1, 2006

(54) Nutrition bar

(75) Inventors: Akhilesh Gautam, Arlington, TN (US); Adela Celeste Garcia, Minneapolis, MN (US); Ricky John Hander, St. James, MN (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, division of Conopco, Inc.

(21) Appl. No.: 11/001,370

(22) Filed: Dec. 1, 2004

(51) Int. Cl. A23L 1/30

(52) U.S. Cl. 426/72

(57) ABSTRACT

A nutrition or other food bar which includes, preferably in moderate to high levels, peptides in the form of hydrated high water activity peptides. The peptides are typically either intact proteins or hydrolyzed proteins. Inclusion of peptides in the form of high water activity peptides helps prevent migration of water from sugars to the proteins which would otherwise result in formation of hard crystalline sugars and food bars which are excessively hard. Whey protein isolate and hydrolyzed whey protein are preferred high water activity peptides.

### BACKGROUND OF THE INVENTION

The popularity of nutrition bars has grown rapidly in recent years. Nutrition bars are convenient vehicles for replacement of a meal and for snacks intended to boost energy. Particularly as a meal replacements, nutrition bars may be used by those seeking to lose weight.

While consumers express a preference for snacks and other foods which are more healthful and which can assist them to achieve their weight loss and other health objectives, they show little inclination to sacrifice the organoleptic properties of their favorite foods or snacks.

When nutrition bars are intended as replacement for a meal, it is particularly important that they contain a range of nutrients. Most preferably, the nutrient mix in the nutrition bar resembles that of the balanced meal which it is intended to replace. However, even where nutrition bars are not intended to replace a meal, a balanced mix of macronutrients and of micronutrients such as vitamins and minerals, may be of benefit.

The last several years have seen a markedly increased focus on diets which emphasize low carbohydrate and higher protein intakes. Accordingly, it has become desirable to consider higher levels of proteins in nutrition bars and other products. However, it is not always possible to accommodate elevated protein levels while preserving the desirable organoleptic properties favored by consumers. It is important also to ensure that a protein-containing nutrition bar maintains its desirable organoleptic properties for an extended shelf life so that consumers are not presented with a bar which has deteriorated. For instance, with time, protein containing bars, especially those with elevated protein levels, tend to become unduly hard and difficult to chew.

Food bars and other food products have included protein in various forms.

Detour bars are high protein bars which include hydrolyzed whey protein.

Jones U.S. Pat. No. 6,749,886 (Nellson Northern Operating Inc.) discloses confectionery bars having a proteinaceous material and a carbohydrate material in a relative weight ratio higher than 1. Proteinaceous materials usually used for the production of previous confectionery bars having protein:carbohydrate ratios lower than 1 are said to possess associated functionality such as high water absorption and high emulsification properties. Jones' invention is said to be directed to the surprising finding that proteinaceous materials having dissociated functionality such as low water absorption and medium to high emulsification properties are suitable for the production of confectionery bars having a protein:carbohydrate weight ratio of higher than 1.

McKenzie U.S. Pat. No. 6,143,335 is directed to a low moisture food bar or cube for supplementing the diets of both animals and humans. The bars include sugar based sweetening agent, fat, vitamins, minerals, medicaments and/or other supplemental ingredients. In a preferred embodiment, the bars weigh about 1 pound and are scored into 1 inch by 1 inch bite sized squares. McKenzie notes that prior bars designed for humans have included relatively high moisture levels and a limited shelf life. Preferably the bars of the invention include 47-82 wt % sugar based sweetening agent, 2-12 wt % fat, and vitamins and minerals at 7.5-12.5 wt %. In addition, the bars may be used to supply amino acids or large amounts of proteins. The bars should have a total moisture content of less than 5 wt %. The water activity of the bar is less than about 0.47, preferably less than 0.43. The bars should have a hardness as measured by a durometer of at least about 70 and preferably about 85-95 to properly score the material. The shelf life is at least 12 months, preferably at least 24 months, particularly when stored in a cool, dry environment.

Bergenfield et al. U.S. Pat. No. 6,221,418 is directed to a dough composition for producing a baked, edible high protein product having a protein concentration based on calories of at least 25 wt %. Also included are flour, leavening agent, sweetening agent and water. Changes in moisture and, concomitantly, hardness are said adversely to affect the texture and mouth feel of many protein supplement bars over a protracted period of time. Extruded high protein products are said generally to lack the textural characteristics of a baked product and tend to turn hard and become unstable over time in all aspects of quality, including taste, texture and appearance, resulting in a shelf life of less than six months.

A mixture of high protein components used in the Bergenfield, et al. dough includes at least one high protein material derived from a vegetable or dairy source, an edible food fiber derived from a vegetable source and an edible emulsifier. The dough is baked for a period of time and at a temperature sufficient to form a baked product but at such temperature and period of time which will not cause a significant amount of denaturing or degradation of the protein present in the formulation. Materials derived from vegetable sources which can be used to form the Bergenfield et al. protein blend include protein available from high protein legumes and grains, such as soy, wheat, rye and rice. Materials which may be used which are derived from dairy sources include casein, sodium caseinate, potassium caseinate, calcium caseinate, dried egg whites, milk powder, whey powder and whey isolates. Preferred sources of vegetable fiber are wheat fiber and inulin. In the final baked product, between about 11 and about 15% moisture is preferred. The products may also include glycerine and lecithin. Whey powder can be added for richness.

Behr et al. U.S. Pat. No. 5,545,414 discloses a nutritional product having a solid matrix containing protein, fat and carbohydrate and including particles of dietary fiber encapsulated in zein. In addition to zein, the protein is preferably a soy protein and may further include calcium caseinate and/or oat protein. The fat is preferably selected from the group consisting of vegetable oils containing less than 25% saturated fatty acids by weight, such as rice bran oil, canola oil, and corn oil.

Behr et al. provide hardness measurements over time for various food bar prototypes. Food bar example 5 is said to demonstrate that soy protein may contribute to hard bar texture. Food bar example 6 is said to demonstrate that a calcium caseinate protein system is beneficial for improving bar texture (hardness). Food bar example 7 is said to demonstrate that a blend of soy protein and calcium caseinate has a positive effect on food bar texture (hardness) relative to a protein system which is 100% soy protein. Food bar example 8 is said to demonstrate that a protein system including a blend of soy protein and whey protein isolate has a positive effect on food bar texture (hardness) as compared to a protein system that is 100% soy protein.

Singer et al. U.S. Pat. No. 4,734,287 discloses proteinaceous, water-dispersible macrocolloids comprising substantially non-aggregated particles of dairy whey protein.

Singer et al. U.S. Pat. No. 4,961,953 is directed to proteinaceous, water-dispersible macrocolloids which in a hydrated state have a substantially smooth, emulsion-like organoleptic character.

Various references disclose food supplements which can be in the form of bars. These include WO 01/56402, Portman U.S. Pat. No. 6,051,236, Gilles et al. U.S. Pat. No. 6,248,375, Anon, “Nutraceuticals-International,” 2000, Vol 5, p 25 (from abstract number 548502), Swartz, ML, “Milk proteins and hydrolysates in nutritional foods,” “Food Ingredients Europe: Conference Proceedings, London, October 1994, published in “Maarssen: Processs Press Europe,” 1994, 73-81 (from Abstract number 373368), Swartz, ML, “Food-Marketing-&-Technology”, vol 9, 4, 6, 9-10, 12, 20 (from abstract number 1995-08-P0036), Kaufman WO 01/33976, Keating et al. EP 768043, WO 03/079818, Sears U.S. Pat. No. 6,140,304 and DeMichele et al. U.S. Pat. No. 6,444,700.

Skelback et al. U.S. Pat. No. 6,444,242 is directed to a microencapsulated oil or fat product wherein at least one oil or fat is dispersed in a matrix material, the oil or fat containing at least 10% by weight of highly unsaturated fatty acids, preferably omega-3 and omega-6 fatty acids. The microencapsulated oil or fat product is obtained by mixing the oil and an aqueous solution of caseinate, and optionally a carbohydrate-containing matrix, homogenizing, and drying the resulting emulsion to obtain free flowing microparticles. The emulsion may be spray dried, preferably in a modified spray dried process at a hot air temperature of 70° C. Fluid bed drying or drum drying may also be used. Infant formula, health functional food, and dietetic foods are among the applications mentioned.

A ZONEPerfect® Nutrition Bar, Lemon Yogurt flavor, available for sale in the United States at least as of Oct. 11, 2004, lists milk protein isolate among its ingredients. The package is marked “BEST BY 11/04.”

Although there have been many previous efforts to formulate nutrition and other food bars, it is desirable to attain improved shelf life with protein containing bars, especially those containing moderate to high levels of protein.

### SUMMARY OF THE INVENTION

The present invention is directed to food bars which include at least 10 wt %, preferably more than 25 wt %, based on the total weight of peptides in the bar, of high water activity peptides. It has been found that food bars which incorporate high water activity peptides, especially non-soy high water activity peptides, are more resistant to hardening over time than typical food bars. By high water activity peptides is meant peptides having a water activity (Aw) of 0.25 or greater, preferably greater than 0.55. Preferably the water activity is less than 0.75 since if the water activity is too high, microbiological problems may ensue. Especially preferred are food bars which show a hardness of less than 1300 gram peak force when measured by Texture Analyzer after treatment under accelerated aging conditions of 85° F. for at least 12 weeks.

Peptides comprise at least two amino acids bonded together by a peptide bond. The term “peptides” encompasses di- and higher peptides as well as polypeptides, ie., proteins. The term “oligopeptides” is used herein to denote di- and higher peptides, but not polypeptides.

The food bars of the invention will generally contain 45 wt %/o or less of peptides including polypeptides and/or oligopeptides, especially from 15 to 35 wt % peptides, more preferably from 20 to 30 wt % peptides.

While not wanting to be bound by theory, it is believed that bar hardening is caused, at least in part, because of the affinity of water for certain proteins. The proteins attract the water and draw it away from sugars and other hydrated ingredients. As a result, the sugars and possibly other ingredients tend to crystallize within the bar, which leads to hardness. By utilizing high water activity proteins, which are hydrated prior to inclusion in the bar, the gradient is altered such that water is not drawn away from the sugars to the proteins, whereby the tendency for the sugars to form hard crystals is diminished or eliminated. Once hydrated, the high water activity bars tend not to lose their moisture because the water is associated with the protein e.g., by hydrogen bonding, so that the tendency not to attract water from other ingredients is maintained.

While it is believed that the alteration in the gradient is at least in part responsible for the improved bar hardening characteristics of bars having high water activity peptides, other mechanisms which may play a role in reducing bar hardness include the less dense packing of the bar which occurs when water is present, and conformational changes in the protein resulting from the presence of moisture.

In a first aspect of the invention, the peptides are proteins. Preferably the proteins are derived from dairy proteins, especially whey. It is less preferred that the high water activity proteins are derived from soy since certain soy proteins have not thus far been found to show the favorable effect. However, it is believed that certain soy proteins may be useful and, of course, soy proteins may be included for other purposes, as well. Other proteins which may be useful include casein and proteins derived therefrom. Non-dairy proteins which may be useful include gelatin.

In accordance with this first embodiment, the food bars of the invention will generally contain 45 wt % or less proteins, especially from 15 to 35 wt % proteins, more preferably from 20 to 30 wt % proteins.

In accordance with a second aspect of the invention, the peptides are high water activity oligopeptides. It is believed that food bars which incorporate high water activity oligopeptides, especially non-soy high water activity peptides, will be more resistant to hardening over time than typical food bars. Oligopeptides can be formed by hydrolyzing proteins such as whey protein isolate. When incorporated into a bar, the high water activity oligopeptides can, like intact proteins, be expected to disrupt any gradient-caused bar hardening. In addition, oligopeptides tend to have a reduced net charge compared to intact proteins. Hydrolysis of the protein makes available more charges due to hydrolysis of the peptide bonds. Although not wanting to be bound by theory, it is believed that available charges tend to cancel each other out to produce a net reduced charge; and since the overall charge is less, the attraction for hydrophillic molecules is less, resulting in further disruption of the gradient thereby leading to even less hardening of the bar with time.

Oligopeptides may, for example, be made from the peptide sources listed above. Examples of oligopeptides include hydrolyzed dairy proteins, especially hydrolyzed whey protein and hydrolyzed casein, as well as hydrolyzed gelatin. Soy is less preferred, but hydrolyzed soy protein may in some circumstances be useful. Peptides may be hydrolyzed, e.g., to an extent of from 2 to 25 e.g., from 5 to 25%.

The food bars of the invention will generally contain 45 wt % or less oligopeptides, including, especially from 15 to 35 wt %, more preferably from 20 to 30 wt %.

The invention is particularly useful for bars which have a moisture content of from 2 to 15 wt %, especially from 4 to 12 wt %, more preferably from 4 to 10 wt %, and an overall bar water activity (Aw) of from 0.45 to 0.65, particularly from 0.55 to 0.6.

While it is believed that the invention will work best for polypeptides and oligopeptides, individual amino acids can be expected also to show the same effect. Therefore, in accordance with a further aspect of the invention, a food bar is provided which includes up to 45 wt % polypeptides and/or oligopeptides and/or amino acids with high water activity, especially from 15 to 35 wt %, more preferably from 20 to 30 wt %.

Peptides useful in the invention will have a high water activity. High water activity peptides may be made by using milder conditions during the isolation of protein solids such that water associated with the protein molecule is not completely driven away. In a preferred process, liquid whey, e.g., having 30-50% solids, is spray dried at from 340-360° F. at a feed pressure from 3300 to 3700 psi and then further dried using a fluid bed. These milder conditions may be used to produce high water activity peptides. Preferably, the peptides are hydrated to an extent of from 0.3 to 0.65 (water activity), especially from 0.5 to 0.6.

Examples of possible peptides which can be made to prepare the high water activity peptides include dairy protein sources such as whey protein isolate and casein, hydrolyzed whey protein, gelatin and, albeit less preferred, soy protein. Similar procedures may be used for amino acids.

For a more complete understanding of the above and other features and advantages of the invention, reference should be made to the following description of the preferred embodiments.

### DETAILED DESCRIPTION OF THE INVENTION

Bar hardness may be measured using the Texture Analyzer, Model TAXt2i, available from Texture Technologies Corp. of Scarsdale, N.Y. The test performed to measure the peak force is a 3 point bending test wherein the bar is supported at two ends and a probe is imposed on the bar at the midpoint between the two supports to ascertain the force needed to cause the bar to break. The distance between the bar supports is set at 50 mm apart. The speed of the descending probe is 2 mm/sec. The trigger value is 5 grams and the distance the arm travels downwardly is 20 mm through to the bottom of the bar.

Water activity may be determined using one of the water activity meters sold under the name of Aqualab by Decagon Devices of Pullman, Wash.

As indicated above, a preferred source of the high water activity peptides is dairy protein, especially whey protein. Whey protein isolate is preferred. Suitable whey protein isolate can be prepared, for example, from liquid whey obtained from cheese manufacture, e.g., in accordance with the process set forth in more detail below. Typically, one starts with liquid whey having 30-50 wt % solids, e.g., 40% solids. The mixture is filtered, as by ultrafiltration or diafiltration, to remove lactose and minerals and to purify the protein to result in an isolate. The isolate may be 90 wt % or above in protein on a dry basis. The isolate may also be prepared by spray drying; various parameters such as inlet temperature, residence time, flow rate and pressure, can be varied to adjust desired properties of the protein. Also, preferably the process provides for recirculation of fines.

Where the peptides employed in the invention are oligopeptides, typically hydrolyzed protein will be processed as described below so as to possess high water activity. A preferred source of high water activity oligopeptide is dairy protein, especially whey protein. Most preferably, the high water activity peptide is hydrolyzed whey protein. Hydrolyzed whey proteins may be prepared from whey, which is by product of cheese manufacture, preferably by an enzymatic process. As with intact proteins, typically a 4-7 wt % solids hydrolyzed protein is filtered, as by microfiltration, ultrafiltration, diafiltration and/or spray drying, to remove fat, lactose and minerals and to purify the protein to result in an isolate. The isolate may be 90 wt % or above in oligopeptide. Where spray drying is used, various parameters such as inlet temperature, residence time, flow rate and pressure, can be varied to adjust desired properties of the oligopeptide. It is believed that other hydrolyzed proteins, such as hydrolyzed soy protein, may be used, as well.

When the high water activity proteins used are hydrolyzed proteins, such as hydrolyzed whey proteins, the protein is preferably hydrolyzed such that the degree of hydrolysis is from 5-25, especially 15-20%. Degree of hydrolysis herein means the ratio of the weight of oligopeptides to the weight of polypeptides, as a percentage.

Where a product with less water than the direct cheese-making byproduct is the starting material, the process can be adjusted, e.g., by lowering the moisture content so that a 40 wt % product is obtained which can then be spray dried under conditions such as those described herein to yield a high water activity hydrolyzed protein.

Useful commercial sources of hydrolyzed whey protein include products sold under the name of Prolong by Proteint of St. Paul, Minn., Biozate by Davisco Foods of Minneapolis, Minn., and WE80FG from DMV Intl of Fraser, N.Y.

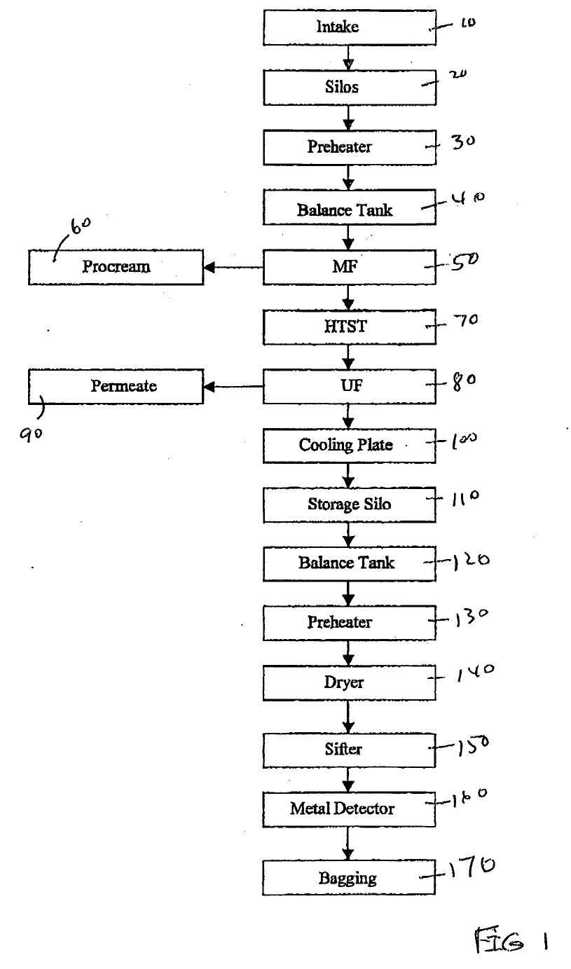

The first steps in the process for preparing a high water activity whey peptide are shown in FIG. 1. A liquid containing roughly 4-7% whey solids is fed through an intake mechanism 10 to silos 20 where it is stored. It is then heated to approximately 40° C. by preheater 30 and fed into balance tank 40, where it is weighed. Subsequently the liquid is subjected to microfiltration using filters 50. A procream 60 is retained by the filters. Procream 60 contains mostly fat and water. The permeate from micofilter 50 is subjected to high temperature short time pasteurization at 70. Following the HTST treatment, the fluid is subjected to ultrafiltration at 80 using a filter. The permeate 90 from the ultrafiltration 80 contains largely lactose and water and comprises approximately 20-25 wt % solids. The retentate is passed on to cooling plate 100 where it is cooled and then stored in storage silo 110. When needed, the retentate stored in silo 110 is transferred to balance tank 120 where it is weighed, and then to preheater 130 where it is heated until the solids content is approximately 30-50 wt % solids, especially 40 wt %.

The 30-50% solids liquid stream is then subjected to a further drying step 140. Typically, the drying step 140 is carried out in 2 steps, first in a spray drier and then a fluid bed. Preferably the liquid whey is spray dried at from 340-360° F. at a feed pressure of from 3300 to 3700 psi and then further dried using the fluid bed to result in an isolate. The isolate may be 90 wt % or above in protein on a dry basis. Various parameters such as inlet temperature, residence time, flow rate and pressure, can be varied to adjust desired properties of the protein. Also preferably the process is arranged to provide for recirculation of the fines. By using relatively mild conditions, the water activity of the peptides so obtained is enhanced since harsher conditions would tend to drive off more moisture.

It will be appreciated that where oligopeptides are employed, the above process would be used except that a hydrolyzed protein would replace the intact starting protein used above.

The food bars of the invention may include sources of unsaturated fatty acids. Among these may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil.

The food bar of the invention may include various other oils or fats. In addition to those mentioned above, such oils and fats include other vegetable fat, such as for example, cocoa butter, illipe, shea, palm, palm kernal, sal, soybean, safflower, cottonseed, coconut, rapeseed, canola, corn and sunflower oils, or mixtures thereof. A blend of oils (e.g., canola, soybean, or high oleic oils) may be used, especially containing either synthetic antioxidants such as BHT, TBHQ or natural antioxidants such as mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. However, animal fats such as butter fat may also be used if consistent with the desired nutritional profile of the product.

If desired, the food bars of the invention may have omega-3 and/or omega-6 fatty acids. Among those which may be useful are included arachidonic acid, docosahexaenoic acid (DHA), eicosapentaenoic acid (EPA), lineoleic acid, linolenic acid (alpha linolenic acid) and gamma-linolenic acid.

In general, oils containing PUFA moieties may be encapsulated, if desired. Where these are used, added antioxidants such as tocopherols, ascorbic acid and/or rosemary extract may be omitted; that is, the oils may be free of added antioxidants. Where non-encapsulated oils containing PUFA moieties are used, it is preferred that added antioxidants such as tocopherols, ascorbic acid and/or rosemary extract be present in the oil.

In the case of a nutrition bar, preferably the amount of fat is not more than 45 wt %, especially not more than 35 wt %, preferably from 0.5 to 10 wt %, still preferably from 0.5 to 5 wt %.

Preferably the food bar of the invention has a water activity of 0.75 or less, preferably 0.65 or less, especially 0.6 or less.

The food bar of the invention include protein sources. Subject to the need for the defined water activity peptides, preferred sources of protein include sources of whey protein such as whey protein isolate and whey protein concentrate, sources of rice protein such as rice flour and rice protein concentrate, and sources of pea protein. Soy protein may also be used. The protein may be present in the food in discrete nuggets, in other forms, or both in nuggets and external to nuggets.

Additional protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. Especially preferred, to minimize the caloric impact, is the addition of protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the foods of the invention, particularly when the food takes the form of a nutrition bar, are preferably within the range of 3 wt % to 45 wt %, such as from 3 wt % to 35 wt %, especially from 3 wt % to 20%.

When protein nuggets are employed, they typically include greater than 50 wt % of protein selected from the group consisting of milk protein, rice protein and pea protein and mixtures thereof, especially between 51 wt % and 99 wt %, more preferably between 52 wt % and 95 wt %, most preferably 55 wt % or above. Other ingredients which may be present in the nuggets would include one or more of other proteins, such as those listed above, include lipids, especially triglyceride fats, and carbohydrates, especially starches.

Carbohydrates can be used in the food of the invention at levels of from 0 to 90%, especially from 1% to 49%. In addition to sweeteners, the fibers and the carbohydrate bulking agents mentioned below, examples of suitable carbohydrates include starches such as are contained in rice flour, flour, peanut flour, tapioca flour, tapioca starch, and whole wheat flour and mixtures thereof. The levels of carbohydrates in the nutrition bar or other bar of the invention as a whole will typically comprise from 5 wt % to 90 wt %, especially from 20% to 65 wt %.

If it is desired to include a bulking agent in the food, a preferred bulking agent is inert polydextrose. Polydextrose may be obtained under the brand name Litesse. Other conventional bulking agents which may be used alone or in combination include maltodextrin, sugar alcohols, corn syrup solids, sugars or starches. Total bulking agent levels in the food bars of the invention, will preferably be from about 0% to 20 wt %, preferably 5% to 16%.

Flavorings are preferably added to the food or nutrition bar in amounts that will impart a mild, pleasant flavor. The flavoring may be in nuggets or or external to the nuggets in the bar or other food, provided that processing is not adversely affected. The flavoring may be any of the commercial flavors employed in nutrition bars or other food bars, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The nutrition bars or other foods are flavored to taste. Suitable flavorants may also include seasoning, such as salt (sodium chloride) or potassium chloride, and imitation fruit or chocolate flavors either singly or in any suitable combination. Flavorings which mask off-tastes from vitamins and/or minerals and other ingredients are preferably included in the products of the invention. Preferably, flavorants are present at from 0.25 to 3 wt % of the food, excluding salt or potassium chloride, which is generally present at from 0 to 1%, especially 0.1 to 0.5%.

Any nuggets and the bar may include colorants, if desired, such as caramel colorant. Colorants are generally in the food at from 0 to 2 wt %, especially from 0.1 to 1%.

If desired, the food bars, especially the nuggets, may include processing aids such as calcium chloride.

The food bars may include emulsifying agents, typical of which are phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides are preferred. The emulsifiers may be present in the bar and/or protein nuggets, at levels overall of about 0.03% to 0.3%, preferably 0.05% to 0.1%. Emulsifiers may be used in combination, as appropriate.

Among fiber sources which may be included in the foods of the invention are fructose oligosaccharides (fos) such as inulin, guar gum, gum arabic, gum acacia, oat fiber, cellulose, whole grains, and mixtures thereof. The compositions preferably contain at least 2 grams of fiber per 56 g serving, especially at least 5 grams of fiber per serving. Preferably, fiber sources are present in the product at greater than 0.5 wt. % and do not exceed 6 wt. %, especially 5 wt. %. As indicated above, additional bulking agents such as maltodextrin, sugar alcohols, corn syrup solids, sugars, starches and mixtures thereof may also be used. Total bulking agent levels in the products of the invention, including fibers and other bulking agents, but excluding sweeteners will preferably be from about 0% to 20%, especially from 1 to 15 wt %. The fiber and the bulking agent may be present in the food as a whole, e.g., the food bar, and/or in nuggets, etc. provided that processing is not impaired.

Carrageenan may be included in the bars or other food of the invention, internal or external to the capsules and nuggets, eg, as a thickening and/or stabilizing agent (0 to 2 wt % on product, especially 0.2 to 1%). Cellulose gel and pectin are other thickeners which may be used alone or in combination, e.g., at 0 to 10 wt %, especially from 0.5 to 2 wt %.

Typically, the food bar will be naturally sweetened. The sweetener may be included in any nuggets or elsewhere in the bar provided that it does not interfere with processing. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Levels of sweeteners and sugar sources preferably result in sugar and/or other polyol solids levels of up to 20 wt %, especially from 10 to 17 wt % of a food bar.

If it is desired to use artificial sweeteners, these may likewise be present in the nugget and/or within the bar, provided that it does not interfere with processing. Any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are used in varying amounts of about 0.005% to 1 wt % on the bar, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%.

Calcium may be present in the nutrition bars at from 0 to 100% of RDA, preferably from 10 to 30% RDA, especially about 25% RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate), copper (e.g., as copper sulfate), and Zinc (as Zinc Oxide). The vitamins and minerals are preferably present at from 5 to 100% RDA, especially 5 to 50% RDA, most especially from about 15% RDA. The vitamins and/or minerals may be included within, or external to, the nuggets, provided that processing and human absorption are not impaired.

RDA as referred to herein is the Recommended Dietary Allowances 10^{th} ed., 1989, published by the National Academy of Science, National Academy Press, Washington, D.C.

Ingredients which, if present, will generally be found within a bar but external to any nuggets include, but are not limited to, rolled oats, chocolate or compound chips or other chocolate or compound pieces, cookie and/or cookie dough pieces, such as oatmeal cookie pieces, brownie pieces, fruit pieces, such as dried cranberry, apple, etc., fruit jelly, vegetable pieces such as rice, honey and acidulants such as malic and citric acids, leavening agents such as sodium bicarbonate and peanut butter.

The food bars of the invention may be made by known methods. Ingredients are added to the foods at a convenient time in the processing, provided that any temperature sensitive ingredients are not exposed to temperatures which cause degradation of their components. Likewise, if protein-containing nuggets are present, the processor must be sensitive to any conditions which could cause degradation of the nugget.

The bars may be single extruded, coextruded, or made by sheeting through a roller (Sollich).

Extruded nutritional or other food bars may be made by cooking a syrup containing liquid (at ambient temperature) ingredients and then mixing with dry ingredients. The mixture is then extruded onto a conveyor belt and cut with a cutter. Any nuggets, e.g., protein nuggets, are included among the dry ingredients. Any nuggets should only be added to the syrup when the syrup is at a temperature below that at which any of the nugget components degrade. Syrup ingredients may include components such as corn syrup, glycerine (0-20 wt % on total product, especially 0.5 to 10 wt %), lecithin and soybean oil or other liquid oils. In addition to the nuggets, other dry components include grains, flours (e.g., rice or peanut), maltodextrin, protein isolates and milk powders.

Food and/or nutritional bars in the form of granola bars may be made by cooking the syrup, adding the dry ingredients, blending the syrup and dry ingredients in a blender, feeding the blended mix through rollers and cutting with a cutter.

The bars of the invention may be coated, eg with milk chocolate or yogurt flavored coating. Chocolates with little or no milk or milk products may be considered so as to maximize the presence of chocolate antioxidants and, if and to the extent desired, to try to avoid reported neutralization of antioxidants in the chocolate by milk or its components.

Typically, excluding moisture lost during processing, the uncoated bars of the invention will be made from 30-50 wt % syrup, especially 35-45%, and 50-70 wt % dry ingredients, especially 55-65 wt %. Generally, coated bars according to the invention will be made from 30-50 wt % syrup, especially 35-45 wt %, 40-50 wt % dry ingredients, especially 40-45% and 0-30 wt % coating (e.g, chocolate or compound coating), especially 5-25 wt %, particularly 10-20 wt % coating.

Nuggets may contain greater than 50 wt %, especially greater than 60%, more preferably greater than 70 or 80% of selected non-soy proteins selected from the group consisting of milk protein, rice protein and pea protein.

It can be expected that the benefits of the invention will be realized in various types of food bars, including various types of nutrition bars having vitamins and minerals including, without limitation, snack bars and meal replacement bars. One example would be granola bars.

Bars according to the invention may be made by combining syrups with salt in a steam jacketed kettle, cooking to 110-240° F., transferring to single or double arm mixer, and then adding at room temperature:

Proteins, and mixing,

Adding flavors and oils, and mixing,

Adding vitamin premix, inulin or other (optional) fiber and cocoa,

Adding cookie pieces, and

Cooling the product to 70-92° F.

The product is then transferred to a bar extruder, such as the bar press machine available from APV Bar Press, Grand Rapids Mich. The bar's core material is extruded into predetermined shape, the typical dimensions of which are 1.5 inch wide and by ⅝ inch thick. The Single length extruded rope is then cut to size using a guillotine cutter. The length is then enrobed in chocolate or chocolate compound coating 98-105° F. and cooled to set the coating (40-60° F.) in a cooling tunnel. The bar is then packaged.

### EXAMPLE 1

### Prophetic

A nutrition bar having the following ingredients (all percentages are by weight of the nutrition bar) is made according to the process set forth above.

| | |
|---|---|
| High fructose corn syrup | 37% |
| corn syrup | 15 |
| salt | 0.2 |
| soy protein isolate | 9.75 |
| high water activity protein | 6.5 |
| calcium caseinate | 9.5 |
| vegetable oil | 1 |
| flavoring | 3.5 |
| vitamin premix | 3.2 |
| Fructose oligosaccharide | 2 |
| (FOS) | |
| Cocoa powder | 5 |
| Cookie pieces | 7 |

40 bars are manufactured as explained above using the above formula. The bars are kept in accelerated storage conditions at 85° F. Initial bar hardness is measured and is found to be around 700 gram peak force using the three point bending test using the Texture Analyzer. Every two weeks, for up to 12 weeks, 6-8 bars are removed from storage and hardness is measured using the Texture Analyzer. The final bar hardness numbers are approximately 1200 g peak force. A control commercially available bar has an initial hardness of 1000 g at week 0. after 12 weeks accelerated storage has a peak force of 3000 g peak force.

### EXAMPLE 2

### Prophetic

A nutrition bar having the following ingredients (all percentages are by weight of the nutrition bar) is made according to the process set forth above.

| | |
|---|---|
| High fructose corn syrup | 37% |
| corn syrup | 15 |
| salt | 0.2 |
| soy protein isolate | 9.75 |
| hydrolyzed whey protein | 6.5 |
| (high water activity) | |
| calcium caseinate | 9.5 |
| vegetable oil | 1 |
| flavoring | 3.5 |
| vitamin premix | 3.2 |
| Fructose oligosaccharide | 2 |
| (FOS) | |
| Cocoa powder | 5 |
| Cookie pieces | 7 |

40 bars are manufactured as explained above using the above formula. The bars are kept in accelerated storage conditions at 85° F. Initial bar hardness is measured and is found to be around 600 gram peak force using the three point bending test using the Texture Analyzer. Every two weeks, for up to 12 weeks, 6-8 bars are removed from storage and hardness is measured using the Texture Analyzer. The final bar hardness numbers are approximately 900 g peak force. A control commercially available bar has an initial hardness of 1000 g at week 0. After 12 weeks accelerated storage the control has a peak force of 3000 g peak force.

It will be appreciated that when fatty acids are mentioned herein, generally these will present in the form of glycerides such as mono-, di- and triglycerides. Therefore, “fatty acids” encompasses glycerides containing them.

Unless stated otherwise or required by context, the terms “fat” and “oil” are used interchangeably herein. Unless otherwise stated or required by context, percentages are by weight.

The word “comprising” is used herein as “including, but not limited to” the specified ingredients. The words “including” and “having” are used synonymously.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A food bar comprising at least 10 wt %, based on the total weight of peptides in the bar, of high water activity peptides.

2. The food bar according to claim 1 wherein said high water activity peptides are hydrated at least to 10 percent prior to inclusion in the bar.

3. The food bar according to claim 1 having at least 20 wt %, based on the total weight of proteins in the bar, of peptides having a water activity of greater than 0.55.

4. The food bar according to claim 1 which show a hardness of less than 1300 g after 12 weeks acclerated storage using a three point bending test on a Texture Analyzer.

5. The food bar according to claim 1 wherein at least 8 wt % of said high water activity peptides are dairy proteins.

6. The food bar according to claim 1 wherein at least 10 wt % of said high water activity peptides are selected from the group consisting of whey proteins, casein and gelatin.

7. The food bar according to claim 1 comprising from 15 to 35 wt % protein.

8. The food bar according to claim 1 having a moisture content of from 4 to 14 wt %.

9. The food bar according to claim 1 comprising 35 wt % or less of peptides.

10. The food bar according to claim 1 wherein the at least 10 wt % high activity peptides are other than soy peptides.

11. The food bar according to claim 1 wherein at least 60 wt % of said high water activity peptides are proteins.

12. The food bar according to claim 1 wherein at least 60 wt % of said high water activity peptides are oligopeptides.

13. A food bar comprising less than 35 wt % protein and having at least 10 wt %, based on the total weight of proteins in the bar, of high water activity oligopeptides.

14. The food bar according to claim 1 having at least 30 wt %, based on the total weight of proteins in the bar, of proteins having a water activity of greater than 0.55.

15. The food bar according to claim 1 which show a hardness of less than 1300 after 12 weeks of accelerated storage at 85° F.

16. The food bar according to claim 1 wherein at least 50 wt % of said high water activity oligopeptides are dairy proteins.

17. The food bar according to claim 1 wherein at least 70 wt % of said high water activity oligopeptides are selected from the group consisting of whey proteins, soy proteins, casein and gelatin.

18. The food bar according to claim 1 wherein said peptides comprise oligopeptides and said oligopeptides comprise from 15 to 35 wt % of said food bar.

19. The food bar according to claim 12 wherein the oligopeptides are selected from the group which includes hydrolyzed whey protein and hydrolyzed soy protein.

20. A food bar comprising at least 10 wt %, based on the total weight of peptides and amino acids in the bar, of high water activity peptides and/or amino acids.
